(19) United States
(12) Patent Application Publication
(10) Pub. No.: US 2026/0119154 A1
(43) Pub. Date: Apr. 30, 2026

(54) METHOD FOR OVER-THE-AIR UPDATE TESTING

(71) Applicant: Beken Corporation, Shanghai (CN)

(72) Inventors: Yanying YU, Shanghai (CN); Hui Liu, Shanghai (CN); Ya Liu, Shanghai (CN); Zhiwei Duan, Shanghai (CN); Long Chen, Shanghai (CN)

(73) Assignee: Beken Corporation, Shanghai (CN)

(21) Appl. No.: 18/983,578

(22) Filed: Dec. 17, 2024

(30) Foreign Application Priority Data
Oct. 31, 2024 (CN) 202411548382.1

(51) Int. Cl. G06F 8/65; G06F 11/3668; G06F 11/3698

(52) U.S. Cl. CPC G06F 8/65; G06F 11/3692; G06F 11/3698

(57) ABSTRACT

The present disclosure relates to a method for testing the robustness of devices during Over-the-Air (OTA) updates. The method involves a testing environment that simulates various anomalies, such as network failures and power outages, to evaluate the device's ability to handle and recover from disruptions during the update process. Example components include a testing management platform, an OTA update server, and a testing platform that includes an anomaly injector and a data monitor. The testing platform introduces simulated anomalies and collects data on the device's response, which is analyzed to assess performance and recovery capabilities. This method ensures that devices can reliably complete updates under adverse conditions by testing their overall performance and robustness. The invention is particularly beneficial for manufacturers aiming to ensure high reliability in their devices such as Internet-of-Thing (IoT) devices and other technology products configured to receive OTA updates.

### CROSS REFERENCE TO RELATED APPLICATION

This application claims priority to and incorporates by reference Chinese patent application no. 202411548382.1 filed 31 Oct. 2024.

### TECHNICAL FIELD

The systems and techniques describe herein relate to firmware or software updates. Specifically, the systems and techniques describe herein evaluate the robustness of Internet-of-Things (IoT) devices or other technology that receive software or firmware updates wirelessly.

### BACKGROUND

Over-the-Air (OTA) updates enable manufacturers or developers to push software or firmware updates, security patches, or feature enhancements to Internet-of-Thing (IoT) devices in real-time, regardless of their geographic locations, maintaining the devices'up-to-date status, fixing security vulnerabilities, and enhancing user experience. OTA upgrades offer a cost-effective solution that allows simultaneous updates of numerous devices without the need for physical contact, significantly reducing maintenance costs and labor requirements. Through OTA upgrades, users can seamlessly receive new functionalities and performance improvements, which enhances their satisfaction. Manufacturers may adjust or optimize product features based on market feedback or user demands.

### BRIEF SUMMARY

A method for testing a device under test (DUT) during an Over-the-Air (OTA) update involves initiating an OTA update that includes a series of operations; injecting one or more anomalies during each of these operations; removing the anomalies after the introduction of the one or more anomalies; receiving log data generated by the DUT in response to these anomalies; evaluating the DUT's performance based on this log data; and generating and displaying a test result based on the evaluated performance. The anomalies tested include network failures, power outages, and server connectivity issues, which are introduced to assess the robustness or recovery capabilities during the OTA update process.

In some embodiments, a testing environment comprises a testing platform equipped with anomaly injectors and data monitors. The testing platform is configured to perform the steps outlined in the method. In some embodiments, the testing platform comprises a non-transitory memory that stores instructions that, when executed, configure the testing platform to perform the steps outlined in the method.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic diagram illustrating an architecture for testing the DUTs, according to some examples.

FIG. 2 is a schematic diagram illustrating the architecture for testing the DUTs, according to some examples.

FIG. 3 is a flowchart illustrating an example method for performing an OTA update, according to some examples.

FIG. 4 is a flowchart illustrating an example method for testing robustness of one or more DUTs during an OTA update, according to some examples.

FIG. 5 is a diagrammatic representation of an example machine, according to some examples.

### DETAILED DESCRIPTION

The systems and techniques described herein relates to testing the robustness of a device, specifically during a process of Over-the-Air (OTA) update. The method involves simulating various disruptions, known as anomalies, such as network disruptions, or power outages, to evaluate how well a device under test (DUT) can handle or recover from these disruptions during the update process. The testing setup includes a testing management platform, an update server, and a testing platform equipped with tools to introduce these anomalies or monitor the status of the DUT. The effectiveness of the DUT in dealing with these anomalies is assessed through collected log data, thereby evaluating the performance or robustness of the DUT during OTA updates.

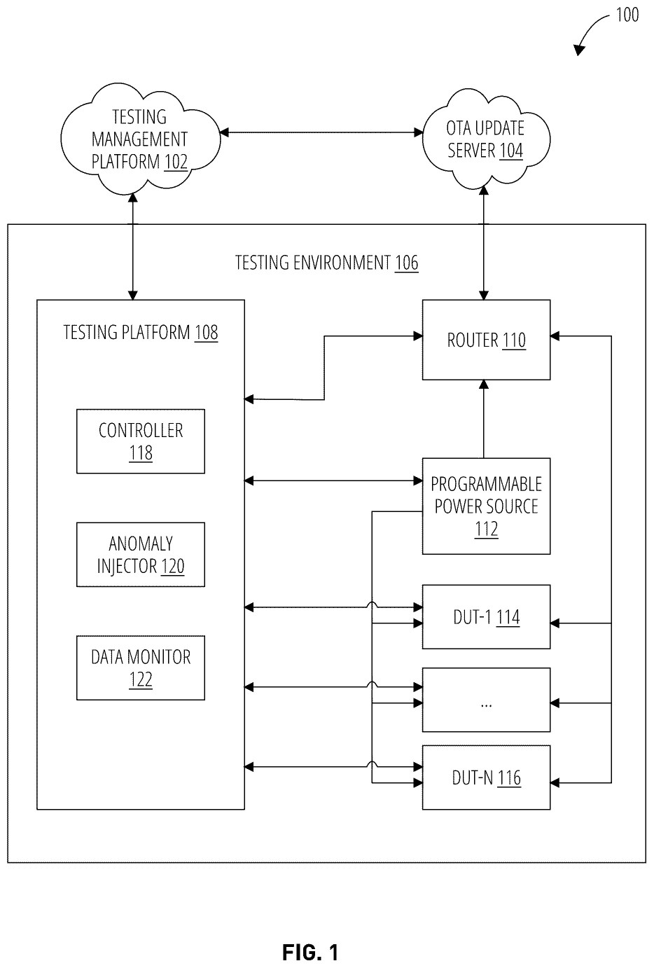

FIG. 1 is a schematic diagram illustrating an architecture for testing the DUTs, according to some examples. The architecture 100 comprises a testing management platform 102, an OTA update server 104, and a testing environment 106.

In some examples, the testing management platform 102 is coupled to one or more testing environments (e.g., testing environment 106) and serves as the command center for the one or more testing environments. In some examples, the testing management platform 102 is communicatively coupled to multiple testing environments (e.g., testing environment 106) and/or testing platforms 108 located in different physical locations.

In some examples, the testing management platform 102 is communicatively coupled to the OTA update server 104 and the testing environment 106. In some other examples, the testing management platform 102 is communicatively coupled to the testing environment 106 via the testing platform 108. In some examples, the testing management platform 102 is communicatively coupled to the OTA update server 104 via an upstream machine within the testing environment 106. The upstream machine may be an intermediary device between the testing management platform 102 and the testing environment 106. The upstream machine lowers the workload on the testing management platform 102 or the testing platform 108. By handling initial data processing and management tasks, the upstream machine reduces the computational burden on both the testing management platform 102 and the downstream testing platform 108, thereby avoid overloading the two platforms, ensuring smoother and more efficient operations. In some examples, the upstream machine enables parallel processing, speeding up the overall testing process. The upstream machine may oversee one or more testing platforms 108. The upstream machine may cause multiple testing platforms 108 to perform testing tasks concurrently, allowing for the simultaneous testing of a large number of devices under test (DUTs). The simultaneous testing of the large number of devices leads to more efficient use of time and resources, achieving quicker turnaround times for testing cycles, which is beneficial in a high-volume production environment. In some examples, the upstream machine improves data management and bandwidth utilization. By performing preliminary data aggregation or filtering before transmitting the information to the central platform, the upstream machine reduces the amount of data that needs to be sent to the testing management platform 102 over the network. This optimization of bandwidth usage ensures faster data transfer and more efficient data management by offloading initial handling tasks from the testing management platform 102. In some examples, the upstream machine is one of the testing platforms 108.

The OTA update server 104 may store the update files. In some examples, the OTA update server 104 is a cloud-storage service that comprises the update files to be downloaded to one or more devices under test (DUTs). In some examples, the OTA update server 104 are communicatively coupled to the one or more DUTs.

The testing environment 106 may be an environment that comprises components configured to conduct tests on the DUTs. The testing environment 106 comprises a testing platform 108, a router 110, a programmable power source 112, and one or more DUTs (e.g., DUT-1 114, DUT-N 116).

In some examples, the testing platform 108 comprises a controller 118, a data monitor 122, and an anomaly injector 120, and the testing platform 108 is communicatively coupled to a router 110, a programmable power source 112, and the one or more DUTs. In some examples, the testing platform 108 is communicatively coupled to the OTA update server 104 via the router 110.

The router 110 may facilitate network connectivity. In some examples, components within the testing environment 106 are connected to the testing management platform 102 and/or the OTA update server 104 via router 110. In some examples, the router 110 connects the one or more DUTs with the OTA update server 104, enabling the DUTs to download updates (e.g., update files) from the OTA update server 104. In some examples, the one or more DUTs are coupled to the testing platform 108 via the router 110. In some examples, the components within the testing environment 106 are linked through additional methods besides the router 110. For example, the testing platform 108 is coupled to the one or more DUTs using cables.

The programmable power source 112 may supply electrical power to the DUTs, the router 110, or other peripheral devices. In some examples, the programmable power source 112 is coupled to the one or more DUTs and the router 110. In some examples, the programmable power source 112 is communicatively coupled to the testing platform 108.

The one or more DUTs are devices to be tested. In some examples, the one or more DUTs is each coupled to a Universal Asynchronous Receiver-Transmitter (UART), allowing the one or more DUTs to communicate with the testing platform 108. A UART may be used to transmit or receive data between two devices using a serial data line. The UART may convert parallel data from the host device into serial form for transmission or converts the received serial data back into parallel form for the host, thereby speeding up data handling and simplifying data processing.

In some examples, the one or more DUTs are IoT devices. IoT devices are physical objects embedded with sensors, software, and other technologies to connect and exchange data with other devices and systems over communication networks, enabling data collection, analysis, and automation. Examples of IoT devices include smart home devices such as thermostats, lighting, plugs, locks, cameras, speakers, doorbells, and appliances; wearable devices like smartwatches, fitness trackers, and health monitors; healthcare devices such as remote patient monitoring systems, smart inhalers, connected contact lenses, and smart pills; industrial devices including smart sensors, connected robots, predictive maintenance systems, and smart meters; agricultural devices like smart irrigation systems, soil sensors, and livestock monitoring tools; transportation and logistics devices including connected vehicles, fleet management systems, smart traffic lights, and asset tracking devices; environmental monitoring devices such as air and water quality sensors and weather stations; retail devices including smart shelves, connected point of sale systems, and smart vending machines; smart city devices like smart streetlights, public safety systems, and waste management systems; energy management devices such as smart grids, energy consumption monitors, and smart HVAC systems; and smart office devices including connected conference rooms, smart desks, and occupancy sensors.

The controller 118 of the testing platform 108 may control various components within the testing environment 106 including the testing platform 108. In some examples, the controller 118 is communicatively coupled to the anomaly injector 120, and the testing platform 108 is communicatively coupled to the programmable power source 112 via the controller 118, allowing the controller 118 to change the behavior of the programmable power source 112.

The anomaly injector 120 of the testing platform 108 may inject (e.g., introduce, simulate, and cause) a simulated anomaly (e.g., fault, disruption, issue, error, and failure) into the DUTs. In some examples, the simulated anomaly includes network failure, communication error, power outage of one or more components in the DUTs. In some examples, the simulated anomaly tests an ability to handle or recover from the unexpected anomaly during an OTA update. It is important to note that the simulated anomaly introduced by an anomaly injector 120 to the testing environment 106 may be simulated for testing purposes only. The simulated anomaly may be designed to mimic potential real-world anomalies but may or may not necessarily represent exact real-world conditions. The purpose of injecting one or more simulated anomalies may be to ensure that a DUT can handle various types of disruptions effectively, thereby enhancing reliability or performance.

The data monitor 122 of the testing platform 108 may receive or monitor data sent by the one or more DUTs during the testing process. The testing platform 108 and/or testing management platform 102 may evaluate the performance of the DUTs by analyzing data received. In some examples, the data sent by the one or more DUTs include log data generated by the one or more DUTs. The data may be sent in real-time or at any chosen frequencies.

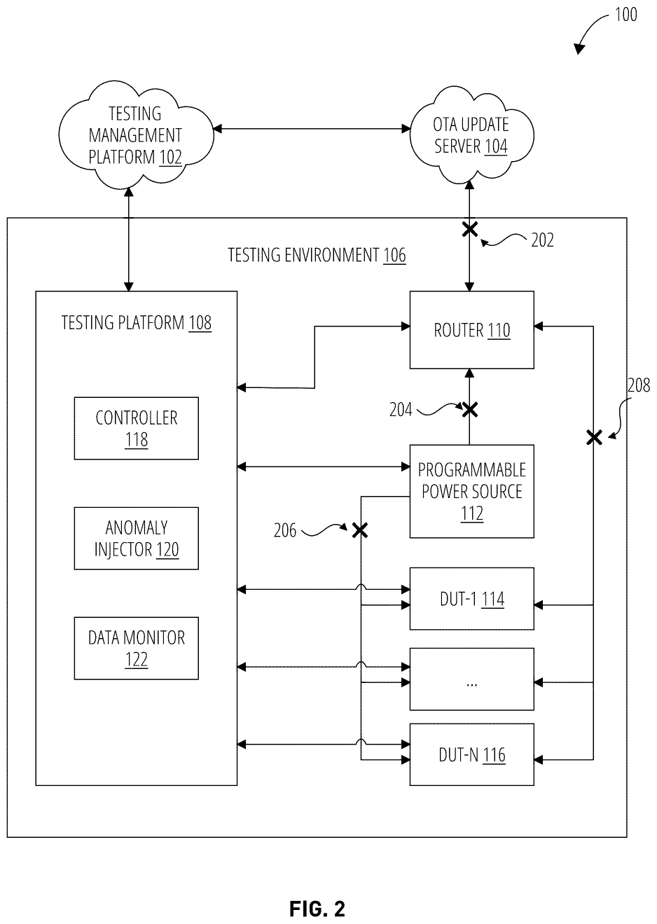

FIG. 2 is a schematic diagram illustrating the architecture for testing the DUTs, according to some examples.

The testing management platform 102 may distribute testing tasks to the one or more testing environments. The testing management platform 102 may generate testing reports. In some examples, the testing management platform 102 is located in a centralized, remote physical location, while a testing environment 106 may be set up in a different physical location. The testing management platform 102 may distribute tasks to one or more of the testing environments 106. In some examples, the testing management platform 102 controls one or more testing environments 106 or components within each testing environment 106, ensuring that all testing procedures are standardized, reducing discrepancies that might arise from having multiple independent testing setups. An administrator may manage or oversee the testing processes via the testing management platform 102, which may provide a testing report that relates to the robustness of the DUTs. The testing management 102 may ensure uniformity and adherence to protocols across different locations. In some examples, having centralized control from the testing management platform 102 makes the testing process scalable. Additional testing environments 106 may be set up quickly for testing more devices. In some examples, centralizing the control of testing tasks enhances data security by ensuring that sensitive information related to the testing procedures or results is stored and managed in a secure or centralized location, reducing the risk of data breaches or unauthorized access that might occur if data were scattered across multiple independent sites.

The OTA update server 104 may store the update files for the DUTs. In some examples, the OTA update server 104 is optional. Instead of downloading the update files from the OTA update server 104, the DUTs download update files from a testing platform 108 via a Local Area Network (LAN) to simulate an over-the-air (OTA) update.

The testing platform 108 may execute, in response to receiving testing tasks from the testing management platform 102, one or more predefined test cases (e.g., test scenarios) on the one or more DUTs. The one or more DUTs may undergo various predefined test cases that replicate real-world operating conditions that may include one or more anomalies, allowing the testing platform 108 to assess (e.g., evaluate, examine, test, check) how well the DUTs performs during the OTA update. The testing platform 108 may assess the ability of a DUT to recover from the one or more anomalies.

The router 110 may facilitate network connectivity among different components within the testing environment 106, such as the testing platform 108 and the one or more DUTs. In some examples, the router 110 provides components within the testing environment 106 access to the testing management platform 102 and/or OTA update server 104.

In some examples, the one or more DUTs are communicatively coupled to a network (e.g., a LAN) through the router 110. As explain above, the testing platform 108 may simulate an OTA update by providing the DUTs with update files via a Local Area Network, instead of having the DUTs connected to the OTA update server 104. In some examples, the router 110 provides simulations of network conditions by managing network traffic or interrupting connections to test the resilience to loss of network connectivity.

The programmable power source 112 may supply electric power to the router 110 and/or the one or more DUTs (e.g., DUT-1 114, DUT-N 116). In some examples, the programmable power source 112 is controlled by the testing platform 108. For example, the testing platform 108 causes the programmable power source 112 to switch off electric power to one or more devices (e.g., DUTs, router 110), thereby simulating various power-related anomalies. In some examples, the testing platform 108 causes the programmable power source 112 to simulate power fluctuations and interruptions, to test the response of the DUTs to different conditions.

The one or more DUTs in the testing environment 106 may be devices being tested for performance, robustness, or resilience during firmware or software updates under various operational conditions. In some examples, the firmware or software updates include the processes of downloading, installing, and rebooting. In some examples, the one or more DUTs receives OTA updates, either directly from an OTA update server or through a LAN setup by the testing platform 108. In some examples, each of the one or more DUTs is coupled to a Universal Asynchronous Receiver-Transmitter (UART), which facilitates communication with the testing platform 108, allowing for efficient transmission of data and/or reception of commands.

In some examples, each DUT of the one or more DUTs autonomously detects and logs a variety of anomalies occurred during firmware or software updates. The each DUT identifies issues such as network connectivity problems, errors during the update decompression, and failures in the reboot process. In response to identifying the anomalies, the each DUT may generate logs that provide data related to the update status, a status of the DUT, and anomalies that occur during the firmware or software updates. The generated logs may be communicated to the data monitor 122 for analysis. The testing platform 108 may determine an outcome of the test, such as failing or passing the test. The logs help fine-tune the firmware or software, thereby enhancing the operational robustness of the DUTs.

In some examples, during the testing process, the testing platform 108 causes one or more actions including but not limited to cutting off communication with the OTA server 202, cutting off power to the router 204, cutting off power to the DUTs 206, and/or cutting off communication with the router 208, simulating the one or more anomalies. The one or more actions may be taken sequentially, concurrently, or in a combination of both.

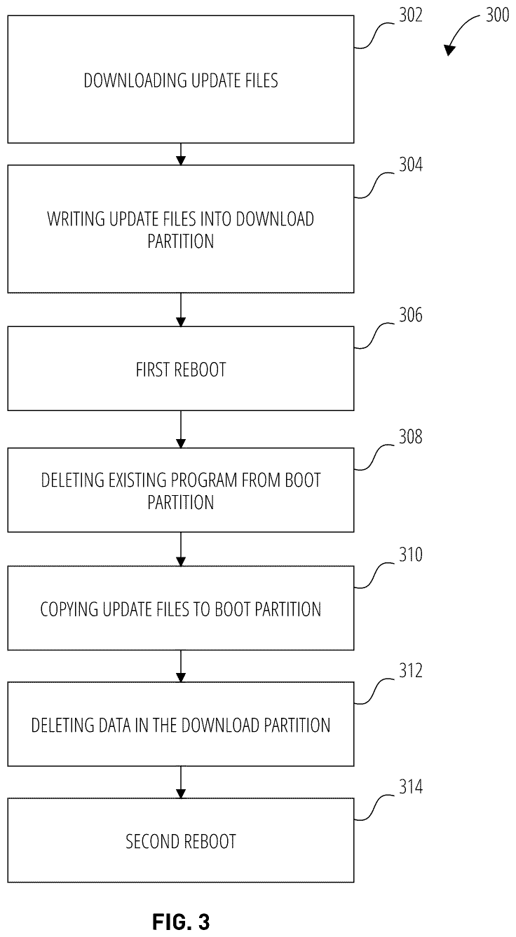

FIG. 3 is flowchart illustrating an example method 300 for performing an OTA update, according to some examples. The sequence of operations (e.g., steps, blocks) depicted is designed for flexibility; although it shows a specific order, modifications to this sequence do not depart from the scope of the present disclosure. Operations may be executed concurrently or in a different sequence that does not materially affect the functionality of method 300. In some examples, various components of a device or system implementing method 300 may perform functions simultaneously or in a specific sequence. In some examples, the OTA update is performed a subset of the operations in the method 300. For example, an OTA update process only comprises operations 302, 304, and 308. In some examples, the roles of the download partition and the boot partition are switched, with the download partition being used as the boot partition and the boot partition being used as the download partition.

In operation 302, a device (e.g., a DUT) may download a update file from an OTA update server (e.g., OTA update server 104). The device may start by establishing a connection to the OTA update server to download the update files. In some examples, the DUT downloads the update files from the testing platform 108 via a LAN.

In operation 304, the device may write the update files associated with one or more updated programs (e.g., an updated application, updated software, updated firmware, updated operation system) to a download partition. The download partition may be a space within a storage device (e.g., memory 506) of the device. In some examples, the download partition may be separate from the boot partition that includes one or more existing programs (e.g., application, software, firmware, operating system) to mitigate disruptions in the event of an update failure and/or to avoid corruption of the updated programs or the existing programs. In some examples, file integrity is verified post-transfer to ensure no corruption occurred during download.

In operation 306, the device may perform a first reboot 306. In some examples, the device undergoes a first reboot 306 in response to writing the update files to the download partition. In some examples, the first reboot 306 is a safety mechanism, ensuring device responsiveness or preventing system freezes during the update process. Should the device fail to reboot correctly, a watchdog program initiates recovery protocols to restore the device to a previous stable state. In some examples, the recovery protocol restores the device by rolling back the firmware and/or software to the existing programs. In some examples, the first reboot 306 is optional.

In operation 308, the device may delete or remove the program(s) stored in the boot partition, clearing out space for any new updates. In some examples, the deleting operation is optional. The device may directly execute the update files from the download partition by using the download partition as the boot partition.

In operation 310, the device may copy the update files associated with the updated programs to the boot partition. In some examples, the downloaded update files are transferred from the download partition to the boot partition. For example, the device copies the update files from the download partition and pastes them in the boot partition. In some examples, the downloaded update files are loaded to the boot partition, next time the device boots up, the updated programs associated with the update files would be executed. As a result, the device would be running the updated programs. In some examples, the update files undergo another integrity check before activation to ensure they are free from corruption.

In operation 312, the device may delete or erase data in the download partition. In some examples, the device deletes the data in the download partition in response to the updated programs having been successfully copied and installed. Operation 312 may free up storage space and ensures that no residual files remain that could interfere with the updated programs.

In operation 314, the device may perform a second reboot 314. In some examples, the second reboot 314 causes the device to execute the updated programs. For example, during the second reboot 314, the bootloader, which is the first piece of software that runs when the device is turned on, accesses the update files that include the updated programs and optionally proceeds to load the updated programs into a main memory of the device. In some examples, the updated programs are executed directly from a partition that stores the update files. The bootloader may hand over control to the updated programs, allowing the updated programs to run as the new firmware, operating system, or application software on the DUT. In some examples, the device utilizes a watchdog timer. The watchdog timer may help recover the device automatically if the device becomes unresponsive for a predefined length of time or encounters critical errors during the reboot process such as failing to boot with the updated programs. In some examples, the recovery process includes taking predefined recovery measures including rebooting again and/or reverting to previous software states.

In some examples, the device has a display for displaying a user interface or notifications. Users may be notified of the availability of updates, given options to schedule the update, or informed of the progress during the update process via the user interface or notifications.

In some examples, the OTA update system is designed to be scalable, capable of handling a small number of devices or scaling up to millions of devices without substantial changes to the core architecture. Manufacturers or developers who may need to deploy updates to a large and diverse fleet of devices may benefit.

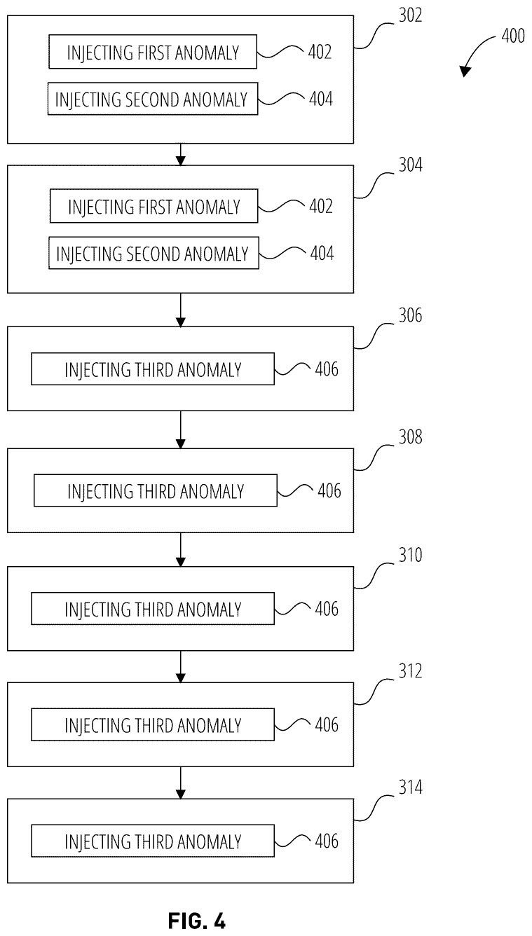

FIG. 4 is a flowchart illustrating an example method 400 for testing robustness of one or more DUTs during an OTA update, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example system that implements the method 400 may perform functions at substantially the same time or in a specific sequence. For clarity, the description below may refer to one or more DUTs; however, the operations of method 300 may be performed by one or more DUTs and operations of method 400 may be performed concurrently on the one or more DUTs.

In some examples, method 400 comprises operations that include introducing one or more anomalies during different operations of the method 300.

In operation 402, the anomaly injector 120 may inject a first anomaly corresponding to a local network disruption before or during the operations of downloading update files 302 and/or writing update files into download partition 304. In some examples, the first anomaly corresponds to a local network disruption within the testing environment 106. The local network may correspond to the network within the testing environment 106.

In some examples, the first anomaly is simulated by turning off the router 110 (e.g., by cutting off power to the router 204). In some examples, the first anomaly is simulated by turning off wireless receptions on the DUT, isolating the DUTs from the local network. In some examples, the first anomaly is simulated using a network virtualization that is used to isolate the DUTs from the network, simulating a disconnection without physically altering the network setup. In some examples, the first anomaly is simulated by setting up firewall rules to block network traffic coming from the DUTs is utilized to deny the DUT access to the local network. In some examples, the first anomaly is simulated using network simulation tools to throttle bandwidth, creating an environment where the DUTs experience network slowdowns (e.g., reducing the available bandwidth from 10 Mbps to 512 Kbps). In some examples, the first anomaly is simulated by periodically disconnecting and reconnecting the network (e.g., by instructing the programmable power source 112 to cut off and then resupply power to the router 110), thereby simulating intermittent network connectivity. In some examples, the testing platform 108 injects the first anomaly by combining any of the examples listed above to assess the robustness of the DUT in handling one or more variations of the first anomaly.

In some examples, the testing platform 108 removes (e.g., stops, stops simulating) the first anomaly by restoring normal local network connectivity and evaluates the robustness of the DUT after the simulated first anomaly has been injected.

In some examples, the testing platform 108 assesses the ability of the DUT to handle local network disruptions without losing or corrupting data, existing programs, and/or the update files during the processes of downloading update files 302 and/or writing update files into download partition 304. In some examples, the testing platform 108 scans (e.g., reads) the download partition of the DUT or performs checksum and/or hash verification for any segments of the update that were downloaded before the disruption occurred. For example, a 1-GB update is interrupted at 700 MB, the platform reads the downloaded 700 MB. The update file might be divided into segments, such as 70 segments of 10 MB each. The testing platform 108 calculates a checksum or hash value (e.g., using SHA-256) for each segment. For example, the hash for the first segment might be e3b0c44298fc1c149afbf4c8996fb92427ae41e4649b934ca495991b7852b855. The testing platform 108 may compare these calculated hashes against expected value predetermined for the testing. If any hash of a segment does not match, indicating potential corruption, the testing platform 108 may mark the segment for re-download. In some examples, the DUT resumes the download from the 700 MB mark, ensuring only the missing or corrupted segments are downloaded, saving bandwidth and time. After the complete download, a final checksum verification may be performed by the testing platform 108 to evaluate the robustness of the DUT.

In some examples, the testing platform 108 examines file size or metadata checks in the download partition. For example, the testing platform 108 determines whether data loss exists based on the sizes of the update files or the data stored in the download partition. In some examples, the testing platform 108 instructs the DUT to complete the update process (e.g., downloading and installing) or perform a test run to ensure the downloaded update files comprising an updated program (e.g., firmware and/or software) works correctly.

In some examples, the testing platform 108 evaluates the robustness of the DUT in response to local network disruptions by checking whether the DUTs resume downloading in response to the recovery of the local network connectivity. In some examples, the testing platform 108 monitors the download progress before and after the disconnection via the data monitor 122. For example, the data monitor 122 receives the log data generated by the DUT to confirm that the download process resumes from the point of interruption and does not restart from the beginning, indicating that the DUT properly handles temporary network disruptions without losing download progress. In response to the network connection being re-established, the DUT may resume the update from the point of interruption.

In some examples, the testing platform 108 assesses the capability of the DUT to revert to a previously stable state following an anomaly during the update process. The testing platform 108 may verify the firmware or software version currently active on the DUT to confirm that the current version matches the version associated with the existing program prior to the update attempt, ensuring the DUT can roll back to a safe operational state in the event of an update failure or interruption.

In some examples, the testing platform 108 monitors the DUT to determine if it successfully resumes the OTA update process after experiencing an anomaly by checking the firmware or software version post-recovery to ascertain that the firmware or software version corresponds with the updated program version. This check confirms that the DUT recovers from the disruption and proceeds to complete the intended update, demonstrating robustness in handling update processes under adverse conditions.

In some examples, the testing platform 108 assesses the ability of the DUT to alert a user or a system administrator of such failures. In some examples, the testing platform 108 receives the log data generated by the DUT. The log data comprises the ability of the DUT to switch networks, such as switching from wireless connection method to a cabled connection method or switching from Wi-fi to cellular network.

In some examples, the testing platform 108 evaluates the fallback procedures of the DUT, such as retrying or maintaining the state of the update process by including any data that has already been downloaded. In some examples, the local network disruption lasts an extended period of time. In these examples, the testing platform 108 may choose to delete the downloaded files and restart the whole process.

In some examples, the testing platform 108 combines one or more of these example scenarios, thereby assessing various abilities of the DUT to handle multiple simultaneous issues, such as network throttling and power interruptions, by monitoring the overall system performance or checking for successful completion of updates. This approach ensures that the DUT is robust and capable of maintaining functionality under various challenging conditions.

In operation 404, the anomaly injector 120 injects the second anomaly corresponding to a server-side connectivity disruption before or during the operations of downloading update files 302 and/or writing update files into download partition 304.

In some examples, the second anomaly is simulated by changing the configuring network settings of the DUT to deny the DUT access to the IP address or domain of the OTA update server 104 before or during the operations of downloading update files 302 and/or writing update files into download partition 304. For example, the DUT runs scripts or network management tools that alter Domain Name System (DNS) settings and routing tables or set up firewall rules to specifically block traffic directed to the OTA update server 104.

In some examples, the second anomaly is simulated by setting server-side configurations on server management software to adjust access controls and reject requests from the DUT based on IP address, MAC address, or other identifying information of the DUT. For example, the OTA update server 104 modifies access control lists (ACLs) or firewall rules to block the DUT, preventing it from communicating with the OTA update server 104.

In some examples, the second anomaly is simulated by employing network virtualization software to create isolated network segments. The network virtualization software configures virtual networks that segregate the DUT into a partition without access to the network segment of the OTA update server 104, isolating the DUT from the server and simulating a network failure that prevents updates.

In some examples, the second anomaly is simulated by disabling Dynamic Host Configuration Protocol (DHCP) to prevent IP address allocation or changing DNS settings to incorrect values are also used to deny access to the LAN or the network comprising the DUTs and the OTA update server.

In some examples, the second anomaly is simulated by simulating network attacks such as distributed denial-of-service (DDoS) attack using automated testing tools. For example, the testing platform 108 generates high volumes of network traffic or simulate other attack vectors to disrupt the connection between the DUT and the OTA update server 104. By overwhelming the network, the testing platform 108 may assess the resilience of the DUT to network congestion and network attacks.

In some examples, the second anomaly is simulated by modifying the configurations in the firmware or software of the DUT to redirect the OTA update server domain to an incorrect or non-existent IP address, thereby isolating the DUT from the OTA update server 104 by causing the DUT to attempt communication with an invalid server address.

In some examples, the second anomaly is simulated by altering the behavior of the OTA update server 104 through the testing platform 108. For example, the testing platform 108 may simulate the OTA update server 104 on a local network. For example, the testing platform 108 introduces deliberate errors in the server responses, such as incorrect update files, corrupted data packets, or invalid response codes.

In some examples, the second anomaly is simulated by temporarily taking the OTA update server 104 offline. The testing platform 108, acting as the simulated OTA server, may periodically go offline or become unresponsive to test how the DUT manages or retries the update process when the OTA update server 104 becomes unavailable.

In some examples, the second anomaly is simulated by implementing rate limiting on the OTA update server 104. The testing platform 108 may limit the number of requests the testing platform 108 accepts from the DUT, causing delays or forcing the DUT to handle throttling scenarios.

In some examples, the second anomaly is simulated by combining any of the above methods. For instance, network virtualization and DNS misconfiguration may be used together to create a more complex testing environment. Combining these methods provides a comprehensive assessment of the ability of the DUT to handle multiple concurrent issues, ensuring robust performance and reliability under various challenging conditions.

The testing platform 108 may assess the ability of the DUT to handle the second anomaly by simulating various types of server access issues. The assessment tests on multiple abilities of the DUT to ensure robust performance.

In some examples, the testing platform 108 removes the second anomaly by restoring normal server-side connectivity and assesses the robustness of the DUT after the simulated second anomaly has been injected.

In some examples, the testing platform 108 assesses the ability of the DUT to maintain data integrity and prevent corruption during server-side connectivity disruptions. For example, the testing platform 108 scans the download partition of the DUT in response to the restoration of the server-side connectivity and performs checksum and/or hash verification on downloaded or written data. The testing platform 108 ensures that data integrity is maintained and that any partially downloaded or written files are intact and usable after the server-side connectivity is resumed. In some examples, the testing platform 108 determines that the DUT has maintained data integrity based on comparing respective data sizes of the boot partition and the download partition with a plurality of predetermined expected values. This comparison includes measuring the actual data sizes stored in both partitions and verifying these against the plurality of predetermined expected values that were established based on the update files. If the data sizes match the plurality of predetermined expected values, the testing platform 108 may confirm that the DUT has successfully preserved the integrity of the data despite the connectivity disruptions, thereby ensuring that no data loss or corruption occurred during the period of server unavailability.

In some examples, the testing platform 108 assesses the ability of the DUT to retry failed connections to the OTA update server. For example, the testing platform 108 monitors, via the data monitor 122, the log data comprising the information of the connection attempts by the DUT, the testing platform 108 assesses whether the DUT periodically retries to connect to the OTA update server 104 in response to the second anomaly. In some examples, the testing platform 108 assesses whether the DUT resumes interrupted processes from the point of server-side connectivity disruptions without restarting the download from the beginning and whether the downloaded and written update files are intact without data loss.

In some examples, the testing platform 108 assesses the ability of the DUT to perform rollback procedures. For example, if the DUT cannot reconnect to the OTA update server after an extended period of time, the DUT to deletes incomplete files (e.g., partially downloaded update files) and restarts the download process. The testing platform 108 may assess the ability of the DUT to handle this process by evaluating the log data or the information related to the download partition. Additional rollback procedures will be discussed in the context of managing a third anomaly.

In some examples, the testing platform 108 assesses the ability of the DUT to alert a user or a system administrator about the second anomaly based on notifications or log data generated by the DUT. The nonfictions and log data may be designed to inform stakeholders of the server-side connectivity disruptions or the steps being taken to mitigate the second anomaly. The testing platform 108 may receive the generated notifications and/or log data and determines whether that these notifications and/or log data are sent promptly (e.g., within a predetermined length of time) or contain sufficient detail, such as including a predetermined number of non-blank entries, to allow for timely intervention and resolution.

In some examples, the testing platform 108 combines multiple example operations listed above to assess one or more abilities of the DUT to handle the second anomaly. For example, the combined operation includes simulating server downtime, introducing network configuration errors, and creating high-traffic conditions. By performing the example assessments of the DUT, the testing platform 108 assesses whether the DUT is robust or capable of maintaining functionality despite server-side connectivity disruptions.

In operation 406, the anomaly injector 120 may inject the third anomaly before or during one or more operations of the method 300. The third anomaly corresponds to a power-related anomaly of the DUT.

In some examples, the third anomaly is simulated by powering off the DUT through a forced shutdown. In some examples, the anomaly is simulated by causing the programmable power source 112 to cut off power to the DUT. In some examples, the third anomaly is simulated by reducing the voltage supply of the programmable power source 112 to a level that is below normal but not completely cutting off the power, thereby simulating various real-world power disruption scenarios. In some examples, for a battery-powered DUT, the third anomaly is simulated by disconnecting the DUT from the battery.

The testing platform 108 assesses the ability of the DUT to handle the third anomaly by simulating various types of power-related disruptions when the DUT is performing one or more operations of the method 300.

In response to the third anomaly having been injected to the DUT, the testing platform 108 may remove the third anomaly by turning the DUT back on and resuming normal power supply, such as switching the DUT back on or by causing the programmable power source 112 to supply power at a normal level. In some examples, the testing platform 108 receives log data generated by the DUT in response to the DUT being turned on, and the testing platform 108 accesses various abilities of the DUT to handle the third anomaly. (For example, based on the log data generated by the DUT).

In examples where the third anomaly is introduced during operations that involve writing data to memory, such as operations 302, 304, and 310, disruptions during data write could result in data corruption or system instability. In examples in which the third anomaly is introduced during operations that involve deleting data from a memory, such as operations 308 and 312, disruptions during data deletion could result in data corruption, inconsistencies, negatively affecting the integrity of other data in the system.

In examples in which the third anomaly is introduced during rebooting, such as operations 306 and 314, disruptions could corrupt the software, firmware, or the bootloader of the DUT. In some examples, the testing platform 108 assesses the effectiveness of the bootloader of the DUT and recovery mechanism in managing unsuccessful reboots: whether the DUT would become inoperable or “bricked”in such a situation.

The testing platform 108 may evaluate the robustness the DUT based on log data generated by the DUT. In some examples, the DUT generates log data that provides information including the operations that the DUT was performing before the third anomaly and operations performed after the third anomaly is resolved. For example, the log data comprises a version of the firmware or software that the DUT is booted into, information regarding the storage unit (e.g., storage unit 518), data size of the different partitions (e.g., first partition, second partition), and the current operations that the DUT is performing (e.g., resuming download, resuming deletion). In some examples, the log data captures not only the event of the power failure but also the state of the DUT at the time of the anomaly. The log data may include logging the operational parameters, such as CPU load, memory usage, and ongoing transactions, which can be crucial for post-event analysis and debugging.

In some examples, the testing platform 108 assesses the ability of the DUT to restore the previous state in response to resolving the third anomaly. For example, in response to the third anomaly, the DUT restore the firmware/software from a previously saved good state (e.g., older version of the firmware/software) or reinitiate the update process. Actions taken by the DUT may be recorded in the log data. The testing platform 108 may assess whether the DUT has taken action according to a predetermined recovery protocol based on the log data.

In some examples, in response to the third anomaly, the DUT conducts a Power-On Self-Test (POST) and generates log data based on the result of the POST. POST is a built-in diagnostic testing sequence that runs automatically when the DUT is powered on. The generated log data may comprise the result of the POST (e.g., whether the DUT completes the POST without errors). In some examples, the result of the POST is indicated by specific audio or visual signal (e.g., beeps, light flashing, or codes). A successful POST confirms that the DUT's basic hardware components, such as the CPU, memory, and essential peripherals, are functioning correctly. The testing platform 108 may assess whether the DUT has recovered from the third anomaly based on the log data generated based on the result of the POST.

In some examples, in response to a startup process after a forced shutdown, the DUT generates log data that provide detailed information about the startup process of the DUT and any errors encountered. The testing platform 108 may access the log data to verify the absence of critical errors or warnings during the startup process. A clean log without any error or warning may indicate that the DUT has resumed normal operations without residual issues from the shutdown.

In some examples, the testing platform 108 assesses whether the DUT has recovered from the third anomaly using heartbeat monitoring. Heartbeat signals may be periodic messages sent by the DUT to indicate that it is operational. The testing platform 108 receives the heartbeat signals via the data monitor 122 to confirm that the DUT is functioning properly. Based on the heartbeat signals being consistent and uninterrupted, the testing platform 108 may determine that the DUT has recovered successfully from the third anomaly.

In some examples, the testing platform 108 assesses whether the DUT has recovered from the third anomaly by checking the status of one or more essential services and processes. The testing platform 108 may send commands to the DUT and verifies responses to ensure that the one or more essential services or processes are running properly. For example, a script could send a command to the DUT to report the status of its various components, such as sensors, actuators, communication modules, the microcontroller, and power management units, and check the response to confirm that these components are operational.

In some examples, the testing platform 108 assesses whether the DUT has recovered from the third anomaly by running tests designed to check the DUT's functionalities. The testing platform 108 may instruct the DUT to perform a series of predefined tasks. Successfully performing the series of predefined tasks may indicate that the DUT has recovered from the third anomaly.

In some examples, the testing platform 108 assesses whether the DUT has recovered from the third anomaly by performing data integrity checks on the DUT. Performing data integrity checks may include reading from both the boot partition and download partitions of the DUT to verify their integrity. In other words, performing data integrity checks comprises scanning the partitions for any inconsistencies or errors. For example, the data monitor 122 check for corrupted boot files, missing critical files, or any anomalies in the boot partition that could prevent the DUT from booting correctly. Similarly, the data monitor 122 checks for data integrity in the download partition, which might store critical updates, log data, or configuration files. The data monitor 122 may scan these partitions to ensure that files are intact and that no data corruption has occurred. The integrity checks include verifying checksums or hashes of files, and comparing them with known good values to detect any alterations.

In some examples, a storage unit of the DUT comprises two partitions, a first partition and a second partition. Prior to a firmware update, the DUT may use the first partition as a boot partition and the second partition as a download partition. After the firmware update, the second partition comprising the updated program may become the boot partition, and the first partition may be used as the download partition. In some examples in which the DUT encounters anomalies during the firmware update, the DUT keeps the first partition as its boot partition, instead of switching to the second partition as the boot partition. The DUT boots into the first partition, using the older firmware stored in the first partition before the next update attempt.

In some examples, the testing platform 108 assesses whether the DUT has recovered from the third anomaly by examining application logs generated by the DUT. These application logs include records of the operations of the DUT or any errors encountered. The testing platform 108 collects or analyzes these application logs to identify any issues that occurred during or after the forced shutdown. The testing platform 108 may determine that the DUT has recovered from the third anomaly based on the application logs indicating that the applications of the DUT are functioning correctly or that no critical errors persist.

In some examples, the testing platform 108 assesses the abilities of the DUT to backup and/or restore files. The testing platform 108 may read from the backup files stored in the DUT and determine if they are intact or have been restored successfully. For example, the testing platform 108 performs checksum and hash verification on the backup files. In some examples, the testing platform 108 performs file size and metadata checks, which comprise verifying that the file size and metadata, such as timestamps and permissions, of the backup files are consistent with the expected values. Any discrepancies in file size or unexpected changes in metadata may indicate corruption or tampering. These checks may help ensure that the backup files have not been altered and are still valid.

In some examples, the testing platform 108 assesses whether the DUT has recovered from the third anomaly by performing client application tests, which ensure that client applications run on a client device (e.g., a cellphone) may connect to and interact with the DUT as expected. In some examples, the testing platform 108 acts as the client device and simulates client interactions to verify that the DUT is accessible and responsive. The testing platform 108 determines that the DUT is accessible and responsive based on the abilities of the DUT to perform typical operations such as data retrieval, updates, and configuration changes. Successful client application tests may confirm that the DUT is operational or can perform intended functions after the forced shutdown caused by the third anomaly.

In some examples, the testing platform 108 assesses the alarm or notification functions of the DUT to ensures that these functions are operational. In some examples, the DUT sends the alarm and/or notification to a client device, the testing platform 108, or a centralized monitoring system such as a cloud-based service (e.g., testing management platform 102). The testing platform 108 determines whether the DUT sends an alarm and/or notification triggered by the third anomaly.

By employing example assessments, the testing platform 108 may evaluate the robustness of the DUT by verifying that the DUT is capable of recovering from the third anomaly, maintaining data integrity, or maintaining functionality. In some examples, the methods for assessing, evaluating, or determining the robustness of the DUT in response to specific anomalies are not confined to a single type of anomaly. The testing platform 108 is designed to apply various assessment techniques interchangeably across different anomalies. For example, the operations to verify data integrity in response to server-side connectivity issues is utilized to assess data integrity following other types of disruptions, such as power-related anomaly or local network failure, allowing the testing platform 108 to adapt to a range of scenarios, enhancing the overall robustness of testing by applying different assessment techniques to various challenges.

Moreover, the scope of anomalies introduced during the OTA update process is not limited to just the first, second, and third anomalies. Additional anomalies may be introduced to further test the resilience and response capabilities under varied and potentially more complex disruption scenarios. The testing methods discussed herein may be applied to test the ability of the DUT to handle the additional anomalies.

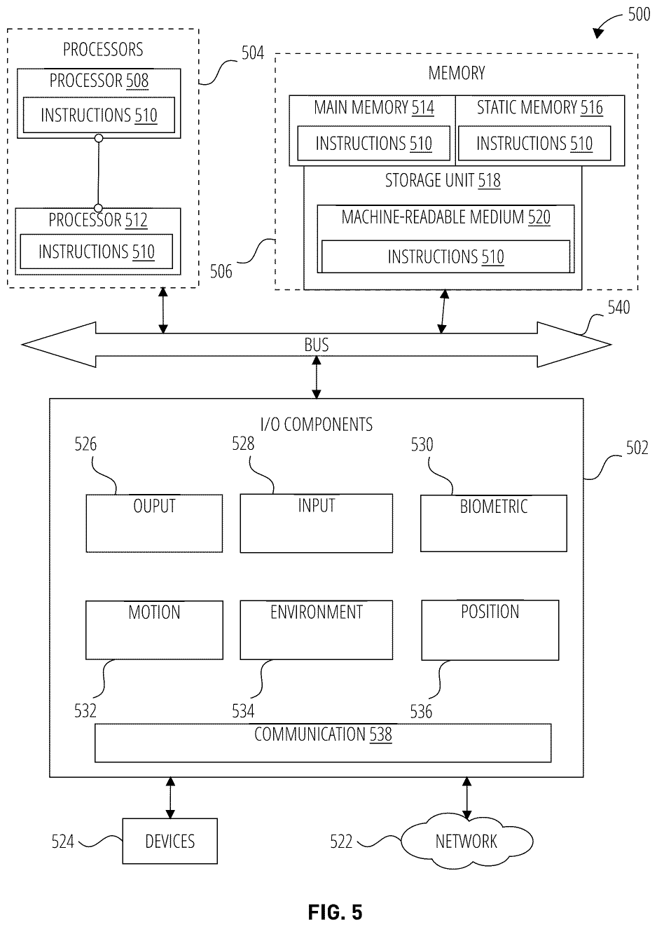

FIG. 5 is a diagrammatic representation of the machine 500 within which instructions 510 (e.g., software, a program, an application, an applet, an app, or other executable code) for causing the machine 500 to perform any one or more of the methodologies discussed herein may be executed. For example, the instructions 510 may cause the machine 500 to execute any one or more of the methods described herein. The instructions 510 transform the general, non-programmed machine 500 into a particular machine 500 programmed to carry out the described and illustrated functions in the manner described. The machine 500 may operate as a standalone device or be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 510, sequentially or otherwise, that specify actions to be taken by the machine 500. Further, while a single machine 500 is illustrated, the term “machine” may include a collection of machines that individually or jointly execute the instructions 510 to perform any one or more of the methodologies discussed herein. In some examples, the testing management platform 102, OTA update server 104, testing platform 108, the one or more DUTs each is an embodiment of machine 500.

The machine 500 may include processors 504, memory 506, and I/O components 502, which may be configured to communicate via a bus 540. In some examples, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 508 and a Processor 512 that execute the instructions 510. The term “Processor” is intended to include multi-core processors that may comprise two or more independent processors (sometimes referred to as “cores”) that may execute instructions contemporaneously. Although FIG. 5 shows multiple processors 504, the machine 500 may include a single processor with a single core, a single processor with multiple cores (e.g., a multi-core processor), multiple processors with a single core, multiple processors with multiples cores, or any combination thereof.

The memory 506 includes a main memory 514, a static memory 516, and a storage unit 518, both accessible to the processors 504 via the bus 540. The main memory 506, the static memory 516, and storage unit 518 store the instructions 510 embodying any one or more of the methodologies or functions described herein. The instructions 510 may also reside, wholly or partially, within the main memory 514, within the static memory 516, within machine-readable medium 520 within the storage unit 518, within the processors 504 (e.g., within the processor's cache memory), or any suitable combination thereof, during execution thereof by the machine 500.

The I/O components 502 may include various components to receive input, provide output, produce output, transmit information, exchange information, or capture measurements. The specific I/O components 502 included in a particular machine depend on the type of machine. For example, portable machines such as mobile phones may include a touch input device or other such input mechanisms, while a headless server machine will likely not include such a touch input device. The I/O components 502 may include many other components not shown in FIG. 5. In various examples, the I/O components 502 may include output components 526 and input components 528. The output components 526 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 528 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 502 may include biometric components 530, motion components 532, environmental components 534, or position components 536, among a wide array of other components. For example, the biometric components 530 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 532 include acceleration sensor components (e.g., accelerometer), gravitation sensor components, rotation sensor components (e.g., gyroscope). The environmental components 534 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 536 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 502 further include communication components 538 operable to couple the machine 500 to a network 522 or devices 524 via respective coupling or connections. For example, the communication components 538 may include a network interface Component or another suitable device to interface with the network 522. In further examples, the communication components 538 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 524 may be another machine or any of a wide variety of peripheral devices (e.g., a peripheral device coupled via a USB).

Moreover, the communication components 538 may detect identifiers or include components operable to detect identifiers. For example, the communication components 538 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF517, Ultra Code, UCC RSS-2D bar code, and other optical codes), or acoustic detection components (e.g., microphones to identify tagged audio signals). In addition, a variety of information may be derived via the communication components 538, such as location via Internet Protocol (IP) geolocation, location via Wi-Fi® signal triangulation, or location via detecting an NFC beacon signal that may indicate a particular location.

The various memories (e.g., main memory 514, static memory 516, and/or memory of the processors 504) and/or storage unit 518 may store one or more sets of instructions and data structures (e.g., software) embodying or used by any one or more of the methodologies or functions described herein. These instructions (e.g., the instructions 510), when executed by processors 504, cause various operations to implement the disclosed examples.

The instructions 510 may be transmitted or received over the network 522, using a transmission medium, via a network interface device (e.g., a network interface component included in the communication components 538) and using any one of several well-known transfer protocols (e.g., hypertext transfer protocol (HTTP)). Similarly, the instructions 510 may be transmitted or received using a transmission medium via a coupling (e.g., a peer-to-peer coupling) to the devices 524.

What is claimed is:

1. A method for testing a device under test (DUT), comprising:
causing the DUT to start an over-the-air (OTA) update that comprises a plurality of steps;
injecting one or more anomalies during each step of the plurality of steps;
removing the one or more anomalies in response to the one or more anomalies having been injected in the each step;
receiving log data generated by the DUT;
evaluating a performance of the DUT for handling the one or more anomalies based on the log data; and
generating and displaying a test result based on the evaluated performance of the DUT.

2. The method of claim 1, wherein the plurality of steps comprises:
downloading one or more update files comprising an updated program;
writing the one or more update files into a download partition of the DUT; and
executing the updated program in response to performing a reboot.

3. The method of claim 2, wherein the one or more anomalies comprise:
a first anomaly corresponding to a local network failure;
a second anomaly corresponding to a server-side connectivity disruption; and
a third anomaly corresponding to a power-related anomaly of the DUT.

4. The method of claim 3, wherein the reboot is a second reboot and the plurality of steps further comprises:
performing a first reboot;
deleting an existing program from a boot partition;
copying the one or more update files to the boot partition; and
deleting the one or more update files from the download partition.

5. The method of claim 3, wherein the injecting the one or more anomalies during the each step of the plurality of steps comprises:
injecting the first anomaly and the second anomaly in response to the downloading the one or more update files comprising the updated program;
injecting the first anomaly and the second anomaly in response to the writing the one or more update files into the download partition of the DUT; and
injecting the third anomaly in response to the performing the reboot.

6. The method of claim 4, wherein the injecting the one or more anomalies during the each step of the plurality of steps comprises:
injecting the first anomaly and the second anomaly in response to the downloading the one or more update files comprising the updated program;
injecting the first anomaly and the second anomaly in response to the writing the one or more update files into the download partition of the DUT;
injecting the third anomaly in response to the performing the first reboot;
injecting the third anomaly in response to the deleting the existing program from the boot partition;
injecting the third anomaly in response to the copying the one or more update files to the boot partition;
injecting the third anomaly in response to the deleting the one or more update files from the download partition; and
injecting the third anomaly in response to the second reboot.

7. The method of claim 5, wherein:
the injecting the first anomaly comprises causing a programmable power source supplying power to a router connecting the DUT to cut off power to the router, thereby simulating the local network failure;
the injecting the second anomaly comprises denying the DUT from accessing to an OTA update server, thereby simulating the server-side connectivity disruption; and
the injecting the third anomaly comprises causing the programmable power source supplying power to the DUT to cut off power to the DUT, thereby simulating the power-related anomaly.

8. The method of claim 6, wherein:
the injecting the first anomaly comprises changing a network setting to block network traffic from the DUT, thereby simulating the local network failure;
the one or more update files being downloaded from a testing platform acting as an over-the-air (OTA) update server;
the injecting the second anomaly comprises denying the DUT from accessing the testing platform, thereby simulating the server-side connectivity disruption; and
the injecting the third anomaly comprises cutting off power supply of the DUT, thereby simulating the power-related anomaly.

9. The method of claim 6, wherein the log data is generated by the DUT in response to the removing each anomaly of the one or more anomalies and the log data comprises information of:
a firmware or software version that the DUT is currently executing;
respective data sizes of the boot partition and download partition; and
operations performed by the DUT in response to the injecting the each anomaly and the removing the each anomaly.

10. The method of claim 9, wherein the evaluating the performance of the DUT for handling the one or more anomalies based on the log data comprises:
determining that the DUT has rolled back to a prior stable state based on the information of the firmware or software version being associated with the existing program;
determining that the DUT has resumed the OTA update based on the information of the firmware or software version being associated with the updated program;
determining that the DUT has maintained data integrity based on comparing the respective data sizes of the boot partition and download partition with a plurality of predetermined expected values; and
determining that the DUT has performed a predetermined recovery protocol as expected based on the information of operations performed by the DUT in response to the injecting the each anomaly and the removing the each anomaly.

11. A testing platform for testing a device under test (DUT) comprising:
one or more hardware processors; and
a memory storing instructions that, when executed by the one or more hardware processors, configure the testing platform to operations comprising:
causing the DUT to start an over-the-air (OTA) update that comprises a plurality of steps;
injecting one or more anomalies during each step of the plurality of steps;
removing the one or more anomalies in response to the one or more anomalies having been injected in the each step;
receiving log data generated by the DUT;
evaluating a performance of the DUT for handling the one or more anomalies based on the log data; and
generating and displaying a test result based on the evaluated performance of the DUT.

12. The testing platform of claim 11, wherein the plurality of steps comprises:
downloading one or more update files comprising an updated program;
writing the one or more update files into a download partition of the DUT; and
executing the updated program in response to performing a reboot.

13. The testing platform of claim 12, wherein the one or more anomalies comprise:
a first anomaly corresponding to a local network failure;
a second anomaly corresponding to a server-side connectivity disruption; and
a third anomaly corresponding to a power-related anomaly of the DUT.

14. The testing platform of claim 13, wherein the reboot is a second reboot and the plurality of steps further comprises:
performing a first reboot;
deleting an existing program from a boot partition;
copying the one or more update files to the boot partition; and
deleting the one or more update files from the download partition.

15. The testing platform of claim 13, wherein the inject the one or more anomalies during the each step of the plurality of steps comprises:
injecting the first anomaly and the second anomaly in response to the downloading the one or more update files comprising the updated program;
injecting the first anomaly and the second anomaly in response to the writing the one or more update files into the download partition of the DUT; and
injecting the third anomaly in response to the performing the reboot.

16. The testing platform of claim 14, wherein the inject the one or more anomalies during the each step of the plurality of steps comprises:
injecting the first anomaly and the second anomaly in response to the downloading the one or more update files comprising the updated program;
injecting the first anomaly and the second anomaly in response to the writing the one or more update files into the download partition of the DUT;
injecting the third anomaly in response to the performing the first reboot;
injecting the third anomaly in response to the deleting the existing program from the boot partition;
injecting the third anomaly in response to the copying the one or more update files to the boot partition;
injecting the third anomaly in response to the deleting the one or more update files from the download partition; and
injecting the third anomaly in response to the second reboot.

17. The testing platform of claim 15, wherein:
the injecting the first anomaly comprises causing a programmable power source supplying power to a router connecting the DUT to cut off power to the router, thereby simulating the local network failure;
the injecting the second anomaly comprises denying the DUT from accessing to an OTA update server, thereby simulating the server-side connectivity disruption; and
the injecting the third anomaly comprises causing the programmable power source supplying power to the DUT to cut off power to the DUT, thereby simulating the power-related anomaly.

18. The testing platform of claim 16, wherein:
the injecting the first anomaly comprises change a network setting to block network traffic from the DUT, thereby simulating the local network failure;
the one or more update files being downloaded from a testing platform act as an over-the-air (OTA) update server;
the injecting the second anomaly comprises denying the DUT from accessing the testing platform, thereby simulating the server-side connectivity disruption; and
the injecting the third anomaly comprises cut off power supply of the DUT, thereby simulating the power-related anomaly.

19. The testing platform of claim 16, wherein the log data is generated by the DUT in response to the removing each anomaly of the one or more anomalies and the log data comprises information of:
a firmware or software version that the DUT is currently executing;
respective data sizes of the boot partition and download partition; and
operations performed by the DUT in response to the injecting the each anomaly and the removing the each anomaly.

20. A non-transitory computer-readable storage medium, the non-transitory computer-readable storage medium including instructions that when executed by a computer, cause the computer to perform operations comprising:
causing a the DUT to start an over-the-air (OTA) update that comprises a plurality of steps;
injecting one or more anomalies during each step of the plurality of steps;
removing the one or more anomalies in response to the one or more anomalies having been injected in the each step;
receiving log data generated by the DUT;
evaluating a performance of the DUT for handling the one or more anomalies based on the log data; and
generating and displaying a test result based on the evaluated performance of the DUT.
